(19) United States
(12) Patent Application Publication
(10) Pub. No.: US 2018/0246579 A1
(43) Pub. Date: Aug. 30, 2018

(54) METHOD EXECUTED ON COMPUTER FOR COMMUNICATING VIA VIRTUAL SPACE, PROGRAM FOR EXECUTING THE METHOD ON COMPUTER, AND COMPUTER APPARATUS THEREFOR

(71) Applicant: COLOPL, Inc., Tokyo (JP)

(72) Inventor: Takao KASHIHARA, Ibaraki (JP)

(21) Appl. No.: 15/853,920

(22) Filed: Dec. 25, 2017

(30) Foreign Application Priority Data
Dec. 26, 2016 (JP) 2016-251506

(51) Int. Cl. G06F 3/01; H04L 12/24; H04L 29/08; G06F 3/0484; G06F 3/0486; G06F 3/0482; G06F 3/0481

(52) U.S. Cl. CPC G06F 3/017; H04L 41/22; H04L 67/141; G06F 3/04815; G06F 3/0486; G06F 3/0482; G06F 3/04847

(57) ABSTRACT

A method includes defining a virtual space associated with a first user, wherein the virtual space includes a first object associated with a second user and a second object different from the first object. The method further includes selecting the first object in response to input by the first user. The method further includes associating the selected first object with the second object within the virtual space in response to input by the first user. The method further includes establishing communication between the first user and second user associated with the first object in response to the first object and the second object being associated with each other.

### RELATED APPLICATIONS

The present application claims priority to Japanese Application No. 2016-251506 filed Dec. 26, 2016, the disclosure of which is hereby incorporated by reference herein in its entirety.

### TECHNICAL FIELD

This disclosure relates to a technology for providing a virtual space, and more particularly, to provision of communication via the virtual space.

### BACKGROUND

A technology of providing a virtual space using a headed-mount device (HMD) is now widely used. For example, in Japanese Patent Application Laid-open No. 2009-223656 A (Patent Document 1), there is described a technology for encouraging communication among a plurality of users by operation of avatar objects presented in a virtual space. In this technology, input of a search condition desired by a user establishes communication between a computer of the user and a computer of another user retrieved based on the search result. With this, in the virtual space, the user can have a conversation with an avatar object (hereinafter referred to as “another avatar object”) corresponding to another user matching the desired search condition.

### PATENT DOCUMENTS

[Patent Document 1] JP 2009-223656 A

### SUMMARY

According to at least one embodiment of this disclosure, there is provided a method including defining a virtual space associated with a first user. The virtual space includes a first object associated with a second user and a second object different from the first object. The method further includes selecting the first object in response to input by the first user. The method further includes associating the selected first object with the second object in response to input by the first user. The method further includes communicating to/from the second user associated with the first object in response to the first object and the second object being associated with each other.

The above-mentioned and other objects, features, aspects, and advantages of the disclosure may be made clear from the following detailed description of this disclosure, which is to be understood in association with the attached drawings.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of an example of a yaw direction, a roll direction, and a pitch direction that are defined with respect to a right hand of the user according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field-of-view image of a user 5A in FIG. 12A according to at least one embodiment of this disclosure.

FIG. 13 A sequence diagram of processing to be executed by a system including an HMD interacting in a network according to at least one embodiment of this disclosure.

FIG. 14 A block diagram of a detailed configuration of modules of the computer according to at least one embodiment of this disclosure.

FIG. 15 A schematic table of an example of a data structure of a student information DB according to at least one embodiment of this disclosure.

FIG. 16 A schematic table of an example of a data structure of a teacher information DB according to at least one embodiment of this disclosure.

FIG. 17 A conceptual diagram of a mode of representation of respective virtual spaces presented by a plurality of computers according to at least one embodiment of this disclosure.

FIG. 18 A sequence chart of a part of processing to be executed by a system including an HMD according to at least embodiment of this disclosure.

FIG. 19 A flowchart of processing to be executed according to at least one aspect of at least one embodiment of this disclosure.

FIG. 20 A flowchart of processing to be executed according to at least one aspect of at least one embodiment of this disclosure.

FIG. 21 A flowchart of processing to be executed according to at least one aspect of at least one embodiment of this disclosure.

FIG. 22 A flowchart of processing to be executed according to at least one aspect of at least one embodiment of this disclosure.

FIG. 23 A flowchart of processing to be executed according to at least one aspect of at least one embodiment of this disclosure.

FIG. 24 A flowchart of an example of a change in object presented in the virtual space according to at least one embodiment of this disclosure.

FIG. 25 A diagram of an example of the change in object presented in the virtual space according to at least one embodiment of this disclosure.

FIG. 26 A diagram of an example of the change in object presented in the virtual space according to at least one embodiment of this disclosure.

FIG. 27 A diagram of an example of the change in object presented in the virtual space according to at least one embodiment of this disclosure.

FIG. 28A A diagram of an example of a state in which communication is established in the virtual space according to at least one embodiment of this disclosure.

FIG. 28B A diagram of an example of the state in which communication is established in the virtual space according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

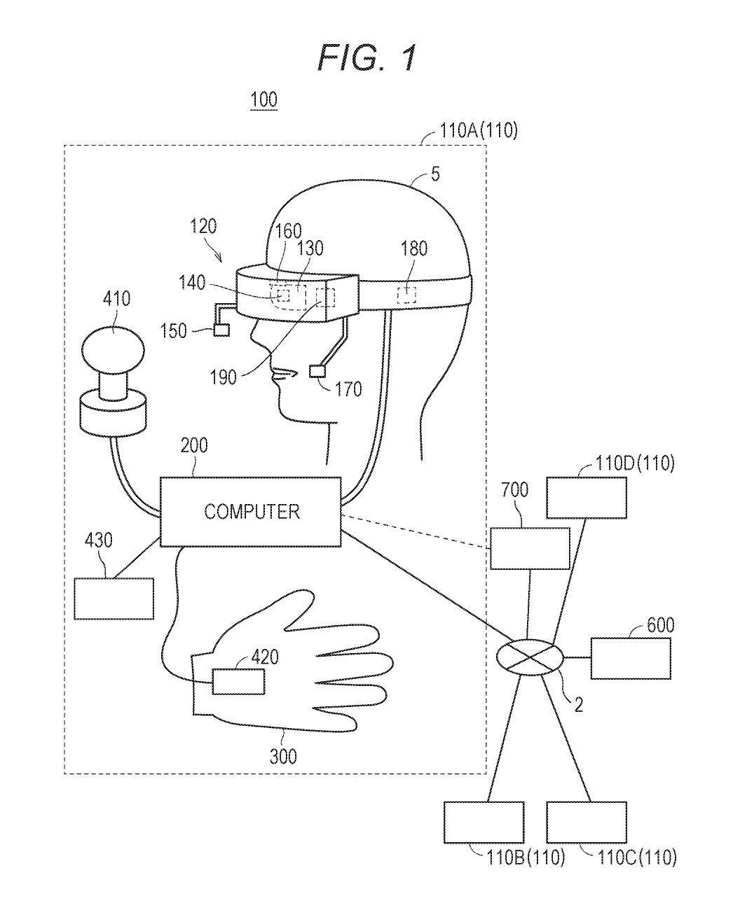

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

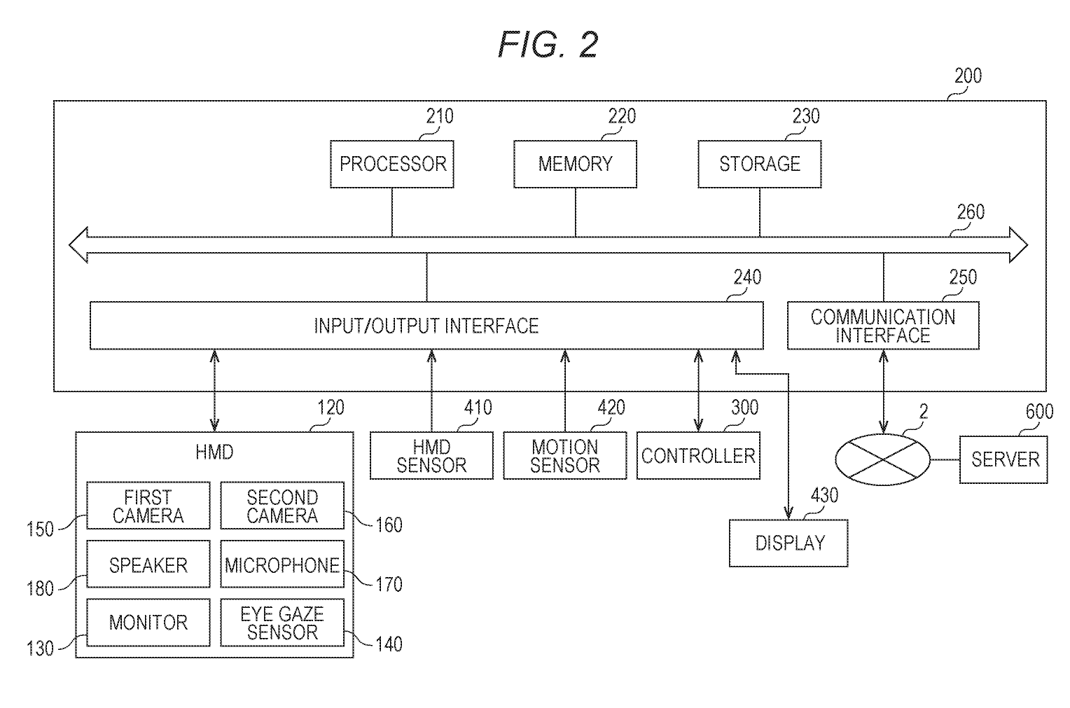

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

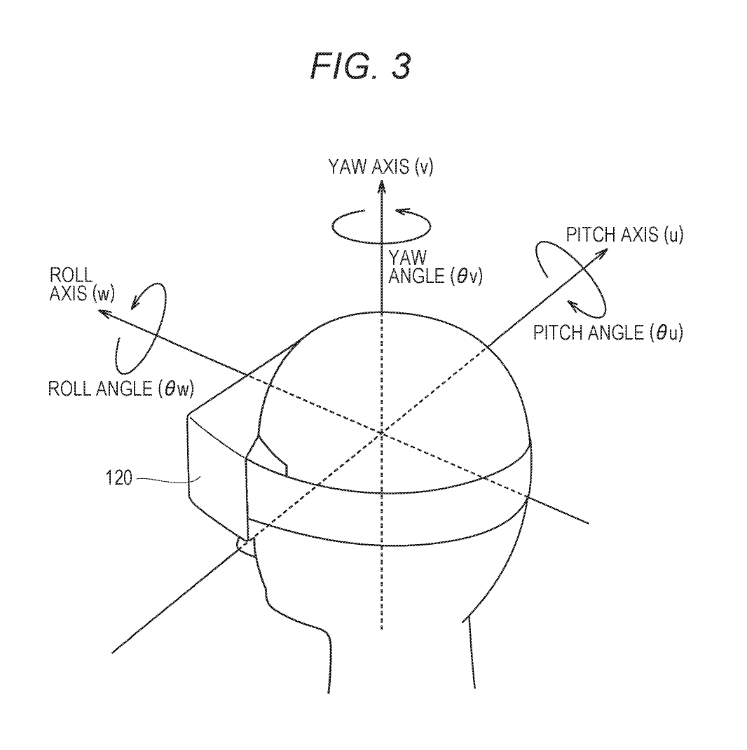

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

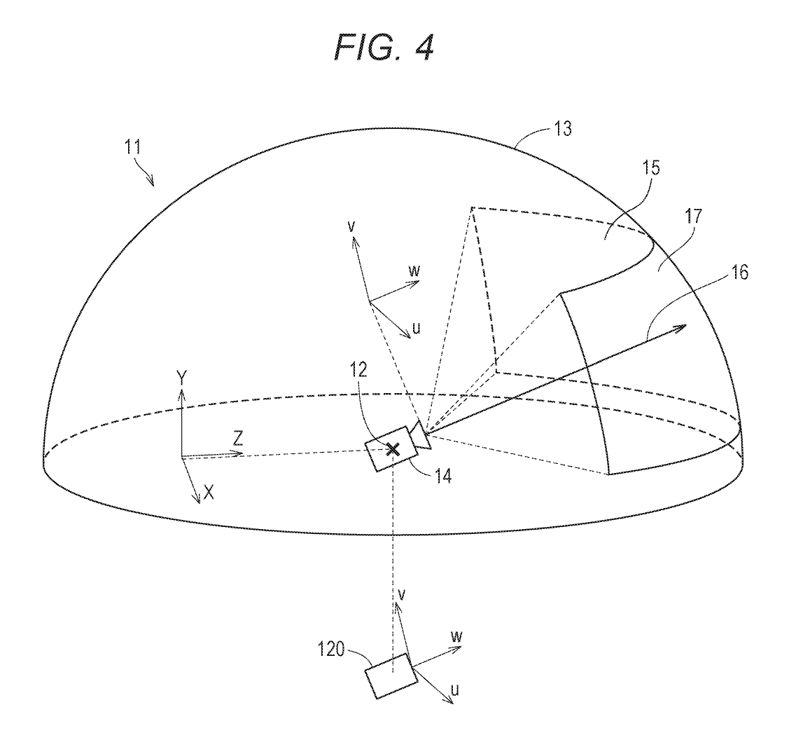

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

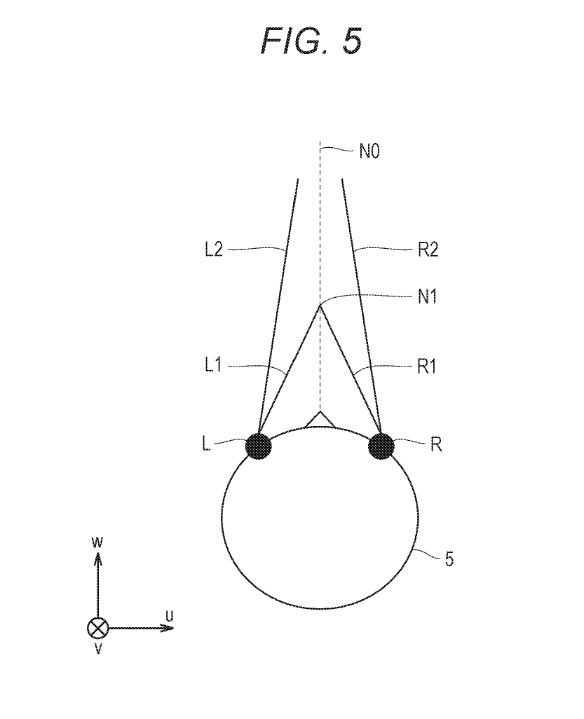

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

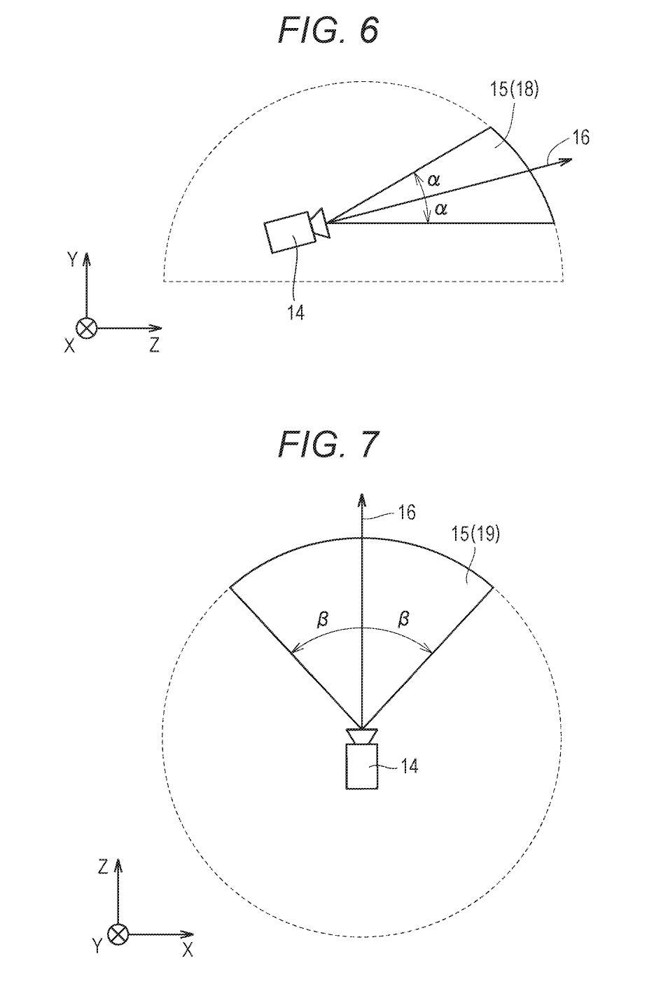

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

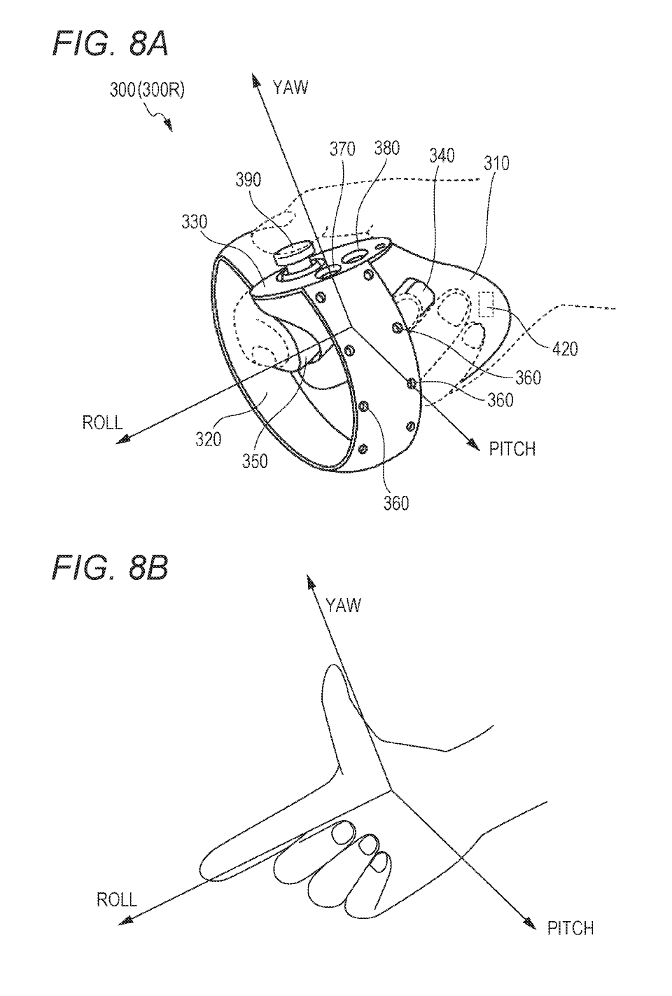

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane defined by the yaw-direction axis and the roll-direction axis when the user 5 extends his or her thumb and index finger is defined as the pitch direction.

[Hardware Configuration of Server]

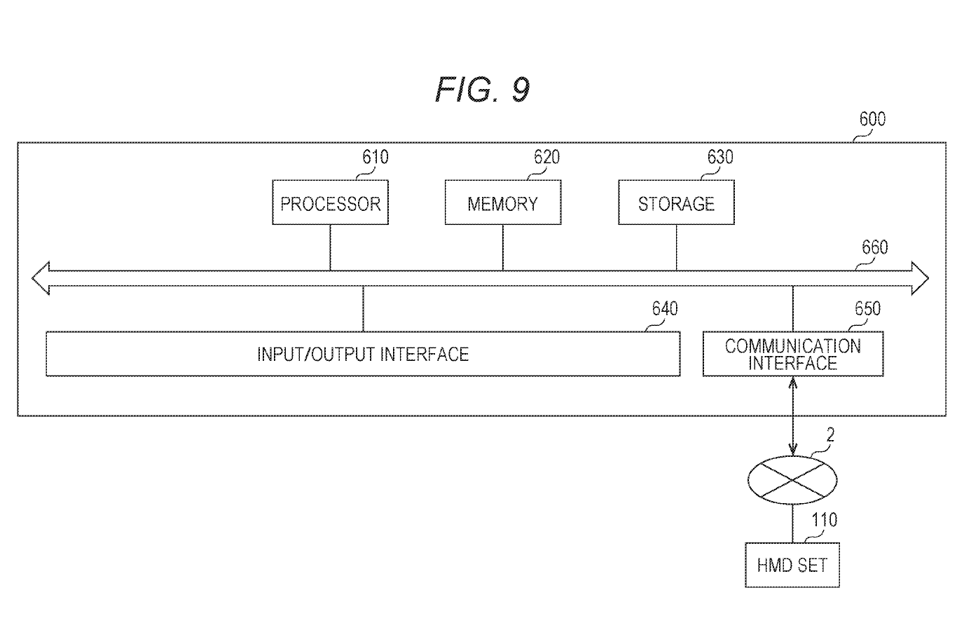

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

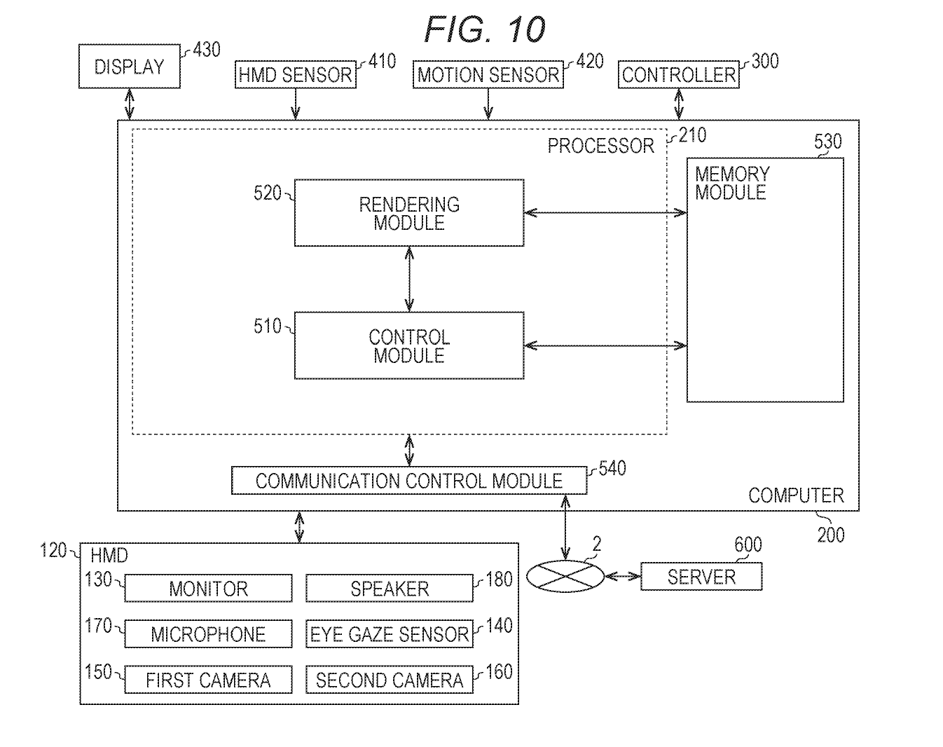

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

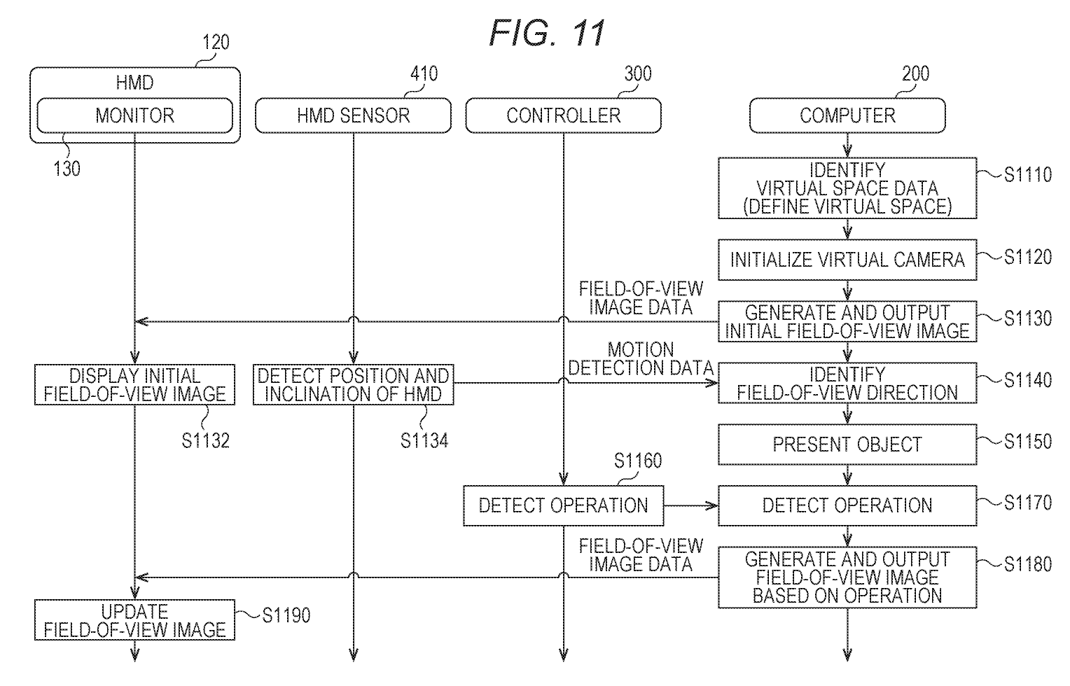

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5.

The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

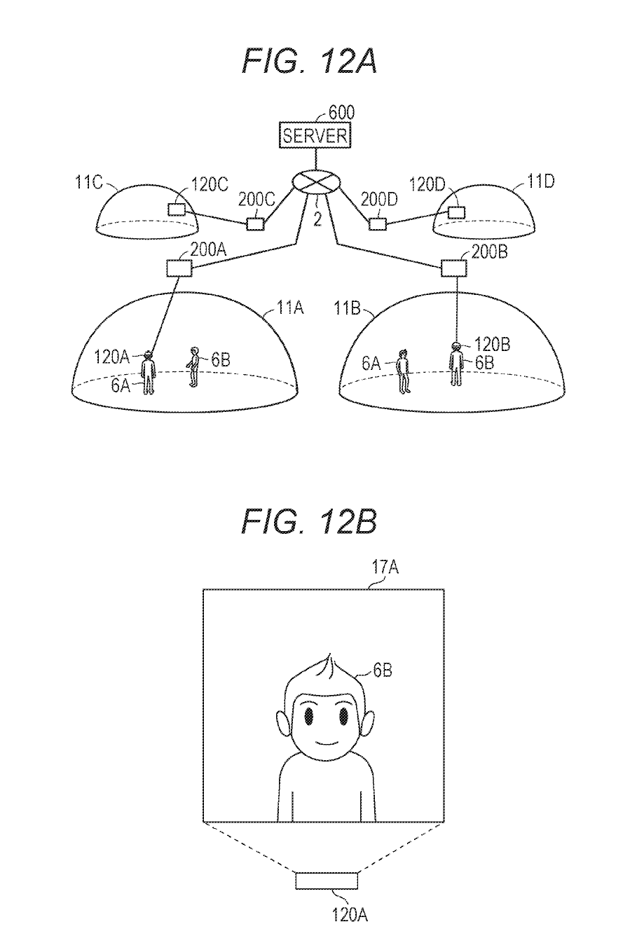

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12 (B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

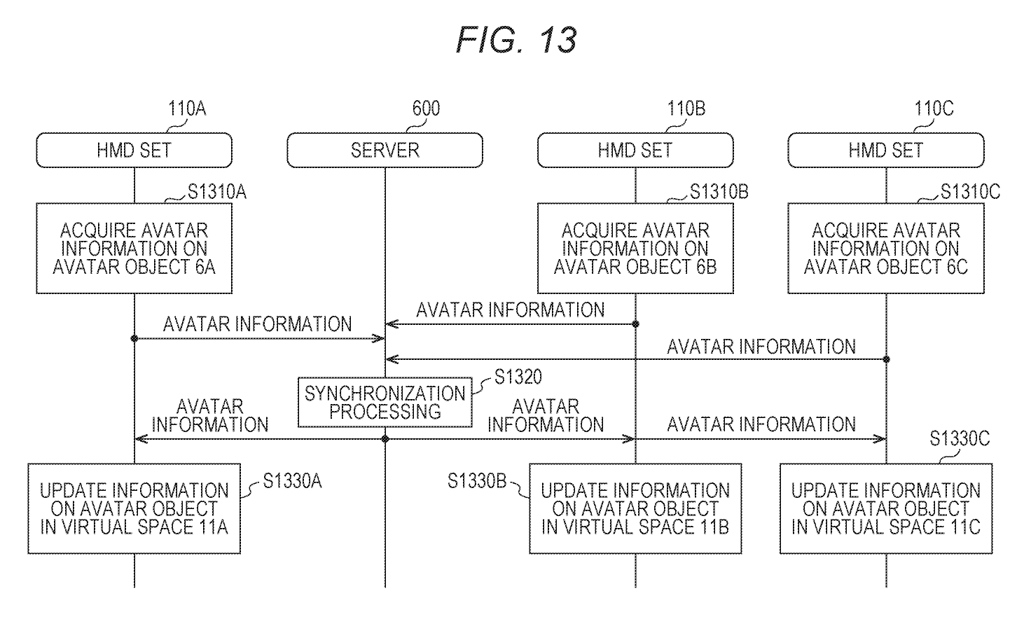

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Detailed Configuration of Modules]

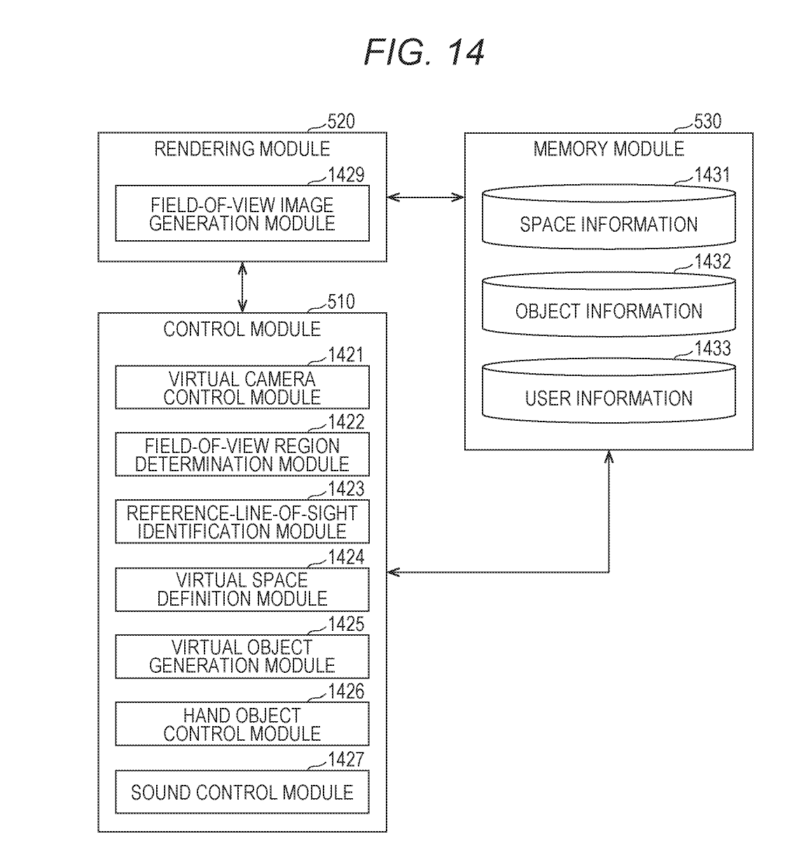

Now, with reference to FIG. 14, a description is given of a detailed configuration of modules of the computer 200. FIG. 14 is a block diagram of the detailed configuration of modules of the computer 200 according to at least one embodiment of this disclosure.

In FIG. 14, the control module 510 includes a virtual camera control module 1421, a field-of-view region determination module 1422, a reference-line-of-sight identification module 1423, a virtual space definition module 1424, a virtual object generation module 1425, a hand object control module 1426, and a sound control module 1427. The rendering module 520 includes a field-of-view image generation module 1429. The memory module 530 stores space information 1431, object information 1432, and user information 1433.

In at least one aspect, the control module 510 controls display of an image on the monitor 130 of the HMD 120. The virtual camera control module 1421 arranges the virtual camera 14 in the virtual space 11, and controls, for example, the behavior and direction of the virtual camera 14. The field-of-view region determination module 1422 defines the field-of-view region 15 in accordance with the direction of the head of the user 5 wearing the HMD 120. The field-of-view image generation module 1429 generates data (also referred to as “field-of-view image data”) on a field-of-view image to be displayed on the monitor 130 based on the determined field-of-view region 15. Further, the field-of-view image generation module 1429 generates field-of-view image data based on data received from the control module 510. The field-of-view image data generated by the field-of-view image generation module 1429 is output to the HMD 120 by the communication control module 540. The reference-line-of-sight identification module 1423 identifies the line of sight of the user 5 based on the signal from the eye gaze sensor 140.

The control module 510 controls the virtual space 11 to be provided to the user 5. The virtual space definition module 1424 generates virtual space data representing the virtual space 11, to thereby define the virtual space 11 in the HMD set 110.

The virtual object generation module 1425 generates data on objects to be arranged in the virtual space 11. The objects may include, for example, another avatar object, a virtual panel, a virtual letter, and a virtual mailbox. Data generated by the virtual object generation module 1425 is output to the field-of-view image generation module 1429.

The hand object control module 1426 arranges a hand object in the virtual space 11. The hand object corresponds to, for example, a right hand or a left hand of the user 5 holding the controller 300. In at least one aspect, the hand object control module 1426 generates data for arranging a hand object corresponding to the right hand or the left hand in the virtual space 11. The hand object control module 1426 generates data for moving the hand object in accordance with operation of the controller 300 by the user 5. The data generated by the hand object control module 1426 is output to the field-of-view image generation module 1429.

In at least one aspect, when motion (e.g., motion of left hand, right hand, left foot, right foot, or head) of a part of the body of the user 5 is associated with the controller 300, the control module 510 generates data for arranging a partial object, which corresponds to a part of the body of the user 5, in the virtual space 11. When the user 5 operates the controller 300 using a part of the body, the control module 510 generates data for moving the partial object. Those pieces of data are output to the field-of-view image generation module 1429.

When the user 5 uses the microphone 170 to utter a sound and the sound control module 1427 detects the utterance from the HMD 120, the sound control module 1427 identifies the computer 200 to which the sound data corresponding to the utterance is to be transmitted. The sound data is transmitted to the computer 200 identified by the sound control module 1427. When the sound control module 1427 receives sound data from the computer 200 of another user via the network 2, the sound control module 1427 outputs from the speaker 180 a sound (utterance) corresponding to the sound data.

The space information 1431 stores one or more templates that are defined to provide the virtual space 11.

The object information 1432 stores content to be reproduced in the virtual space 11 and information for arranging an object to be used in the content. The content may include, for example, game content and content representing landscapes that resemble those of the real world. Further, the object information 1432 includes data for arranging, in the virtual space 11, a hand object corresponding to the hand of the user 5 operating the controller 300, data for arranging an avatar object of each user in the virtual space 11, and data for arranging other objects, for example, a virtual panel, in the virtual space 11.

The user information 1433 stores, for example, a program for causing the computer 200 to function as a control device for the HMD set 110 and an application program that uses each piece of content stored in the object information 1432.

[Data Structure of DB of Server 600]

The storage 630 of the server 600 includes a student information DB 630-1 and a teacher information DB 630-2 as databases (DB) for storing data. The server 600 according to at least one embodiment of this disclosure provides an online English lesson service in the virtual space 11. In this online English lesson service, an avatar object corresponding to a student is able to take an English lesson from an avatar object corresponding to a teacher. The student information DB 630-1 stores data on students who receives the online English lesson service. The teacher information DB 630-2 stores data on teachers who receives the online English lesson service.

[Data Structure of Student Information DB]

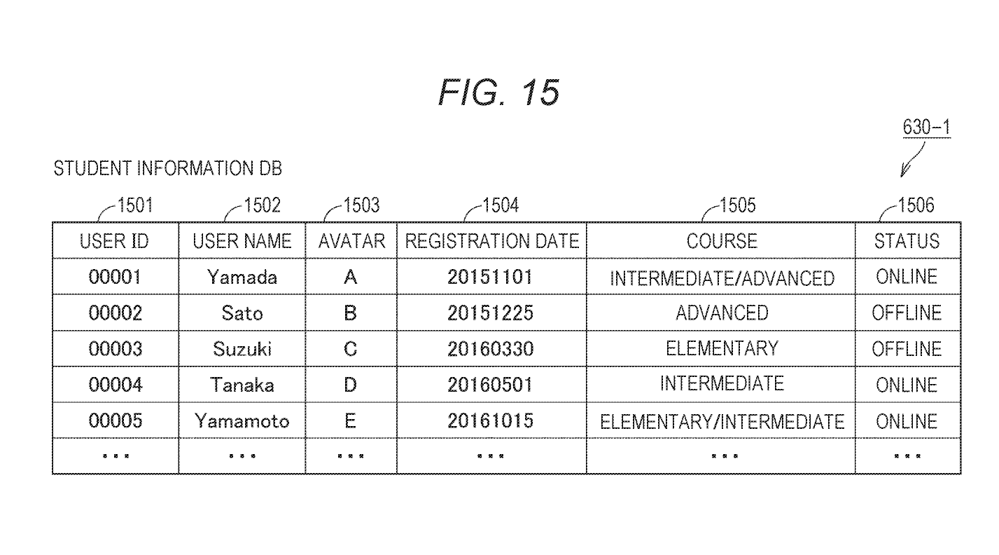

Referring to FIG. 15, a description is given of an example of a structure of data to be stored in the student information DB 630-1. FIG. 15 is a schematic table of an example of a data structure in the student information DB 630-1 according to at least one embodiment of this disclosure.

In FIG. 15, in at least one aspect, the student information DB 630-1 includes user ID data 1501, user name data 1502, avatar data 1503, registration date data 1504, course data 1505, and status data 1506.

The user in FIG. 15 is a student who takes an English lesson. The user ID data 1501 is data indicating the ID (user ID) of a user. The user name data 1502 is data indicating the name (user name) of a user. The avatar data 1503 is data indicating a user's avatar object. The registration date data 1504 is data indicating a date on which a user is registered in the online English lesson service. The course data 1505 is data indicating a course of the online English lesson service in which a user is registered. The status data 1506 is data indicating whether or not a user is online in the online English lesson service.

For example, in the case of Yamada, who is a student, the user ID data 1501 is “00001”. The user name data 1502 is “Yamada”. The avatar data 1503 is “A”. The registration date data 1504 is “20151101”. The course data 1505 is “intermediate or advanced”. The status data 1506 is “online” or “offline”. Data stored in the student information DB 630-1 is not limited to the specific example described above.

[Data Structure of Teacher Information DB]

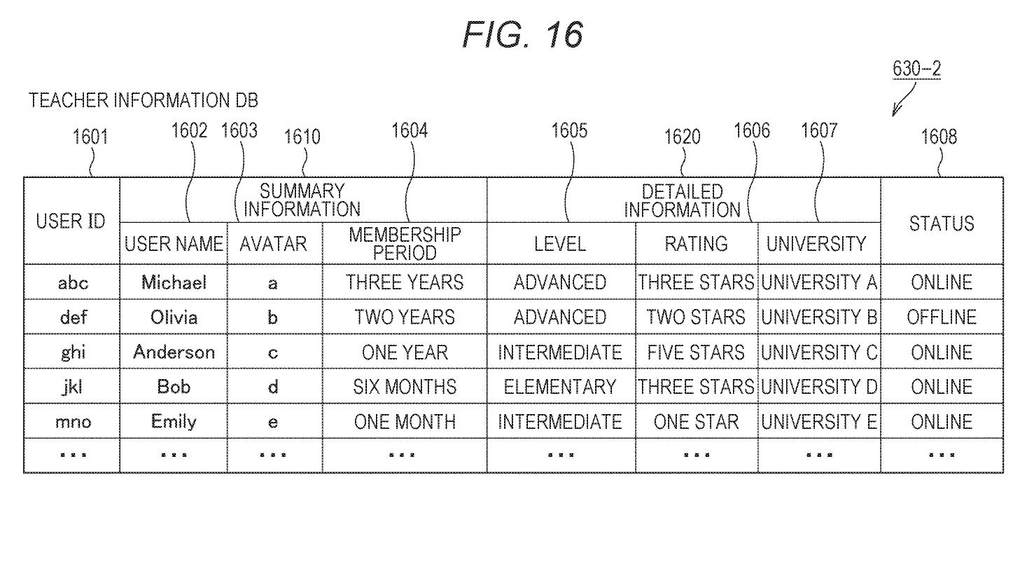

Referring to FIG. 16, a description is given of an example of a structure of data to be stored in the teacher information DB 630-2. FIG. 16 is a schematic table of an example of a data structure in the teacher information DB 630-2 according to at least one embodiment of this disclosure.

In FIG. 16, in at least one aspect, the teacher information DB 630-2 includes user ID data 1601, summary information data 1610, detailed information data 1620, and status data 1608.

The user shown in FIG. 16 is a teacher who provides an English lesson. The user ID data 1601 is data indicating the ID (user ID) of a user. The summary information data 1610 is data indicating summary information on a user. The detailed information data 1620 is data indicating detailed information on a user. The detailed information data 1620 is more detailed information on a user than the summary information data 1610. The status data 1608 is data indicating whether or not the user is online in the online English lesson service.

In at least one aspect, the summary information data 1610 includes user name data 1602, avatar data 1603, and membership period data 1604. The user name data 1602 is data indicating the name (user name) of a user. The avatar data 1603 is data indicating the avatar object of a user. The membership period data 1604 is data indicating a period (membership period) during which the user receives the online English lesson service.

In at least one aspect, the detailed information data 1620 includes level data 1605, rating data 1606, and university data 1607. The level data 1605 is data indicating a course of the online English lesson service taught by a user. The rating data 1606 is data indicating a rating given by students to a user. The university data 1607 is data indicating a university from which a user has graduated or a university in which a user is enrolled.

For example, in the case of Michael, who is a teacher, the user ID data 1601 is “abc”. The user name data 1602 is “Michael”. The avatar data 1603 is “a”. The membership period data 1604 is “3 years”. The level data 1605 is “advanced”. The rating data 1606 is “three stars”. The university data 1607 is “University A”. The status data 1608 is “online” or “offline”. Data stored in the teacher information DB 630-2 is not limited to the specific example described above.

[Interaction Between Users on Network]

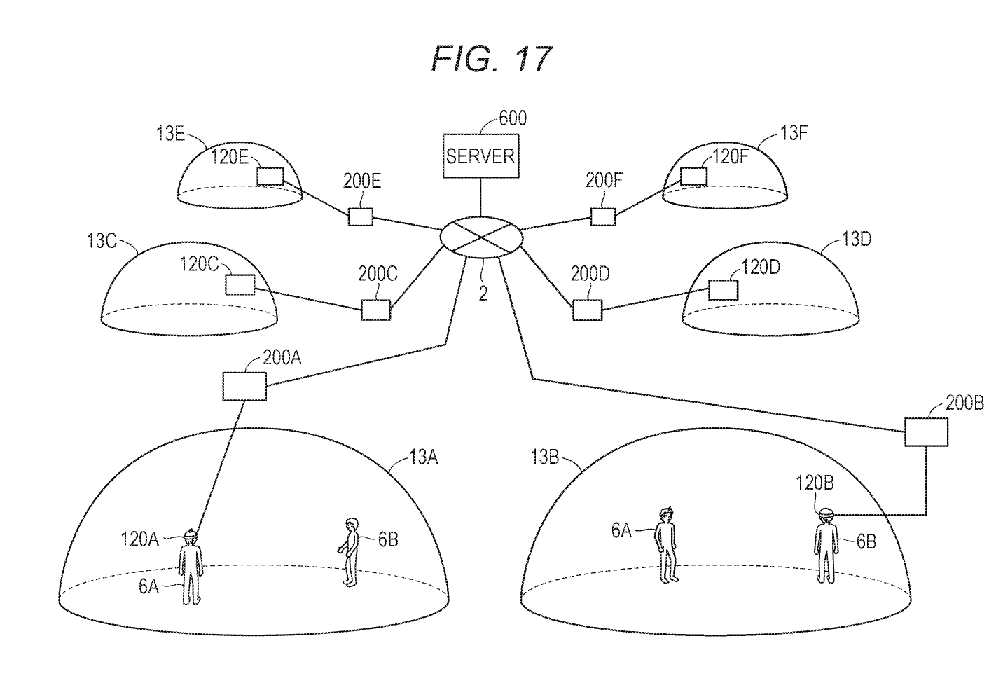

Referring to FIG. 17, a description is given of interaction between users in the network 2. FIG. 17 is a conceptual diagram of one mode of representation of the respective virtual spaces 11 presented by the plurality of computers 200 according to at least one embodiment of this disclosure.

In FIG. 17, each of the computers 200A to 200F is able to communicate to/from the server 600 via the network 2. In at least one aspect, any one of the computers 200A to 200F is a computer owned by a student or a teacher who receives the online English lesson service. The computers 200A to 200F provide panorama images 13A to 13F in the corresponding HMDs 120A to 120F. The panorama images 13A to 13F present avatar objects corresponding to the users of the respective computers 200A to 200F.

For example, the avatar object 6A corresponds to the user 5A of the HMD 120A. In at least one aspect, the user 5A of the HMD 120A is a teacher who teaches the online English lesson service. Meanwhile, the avatar object 6B corresponds to the user 5B of the HMD 120B. In at least one aspect, the user 5B of the HMD 120B is a student who receives the online English lesson service. When the teacher and the student have a conversation with each other in the virtual space 11, the avatar object 6B corresponding to the student is presented in the panorama image 13A visually recognized by the teacher. Meanwhile, the avatar object 6A corresponding to the teacher is presented in the panorama image 13B visually recognized by the student.

The HMDs 120A to 120F transmit pieces of motion detection data corresponding to the positions and inclinations of the respective users to the server 600. The server 600 receives the motion detection data from each of the HMDs 120A to 120F for transmission to the other HMDs 120 in the network 2. The other HMDs 120 change the positions and inclinations of other avatar objects based on those pieces of motion detection data.

The HMDs 120A to 120F transmit pieces of sound data corresponding to the utterance of the respective users to the server 600. The server 600 receives those pieces of sound data from the HMDs 120A to 120F for transmission to the other HMDs 120 in the network 2. The other HMDs 120 change how much the mouths of other avatar objects open based on those pieces of sound data. The other HMDs 120 output sounds that are based on the sound data from the speaker 180.

In this manner, motion or utterance of a certain user 5 in the real space changes the position or facial expression of an avatar object corresponding to the user 5 in the virtual space 11. Then, through such motion or utterance of another user in the real space as to respond to this change, the position or facial expression of an avatar object corresponding to another user is changed in the virtual space 11. In this manner, interaction between users wearing the different HMDs 120 is implemented in the virtual space 11 by using communication in the network 2.

[Control Structure of HMD Set]

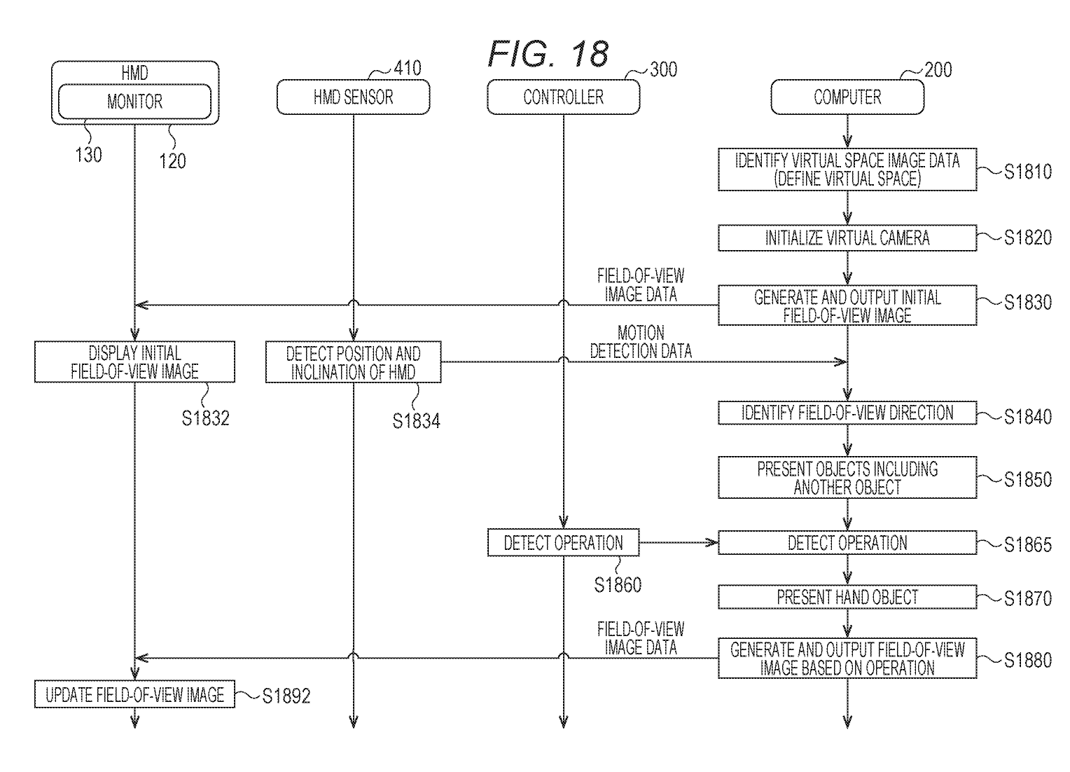

Referring to FIG. 18, a description is given of the control structure of the HMD set 110. FIG. 18 is a sequence chart of a part of processing to be executed by the HMD set 100 according to at least one embodiment of this disclosure.

In FIG. 18, in Step S1810, the processor 210 serves as the virtual space definition module 1424 to identify virtual space image data and define the virtual space 11.

In Step S1820, the processor 210 initializes the virtual camera 14. For example, in a work area of the memory, the processor 210 arranges the virtual camera 14 at the center defined in advance in the virtual space 11, and matches the line of sight of the virtual camera 14 with the direction in which the user 5 faces.

In Step S1830, the processor 210 serves as the field-of-view image generation module 1429 to generate field-of-view image data for displaying an initial field-of-view image. The generated field-of-view image data is output to the HMD 120 by the communication control module 540.

In Step S1832, the monitor 130 of the HMD 120 displays the field-of-view image based on the field-of-view image data received from the computer 200. The user 5 wearing the HMD 120 may recognize the virtual space 11 through visual recognition of the field-of-view image.

In Step S1834, the HMD sensor 410 detects the position and the inclination of the HMD 120 based on a plurality of infrared rays emitted from the HMD 120. The detection results are output to the computer 200 as motion detection data.

In Step S1840, the processor 210 identifies a field-of-view direction of the user 5 wearing the HMD 120 based on the position and inclination of the HMD 120, which are included in the motion detection data.

In Step S1850, the processor 210 executes an application program, and presents objects in the virtual space 11 based on a command included in the application program. The objects to be presented at this time include another avatar object.

In Step S1860, the controller 300 detects operation of the user 5 based on a signal output from the motion sensor 420, and outputs detection data representing the detected operation to the computer 200. In at least one aspect, operation of the controller 300 by the user 5 is detected based on an image captured by a camera arranged around the user 5.

In Step S1865, the processor 210 detects operation of the controller 300 by the user 5 based on the detection data acquired from the controller 300.

In Step S1870, the processor 210 generates field-of-view image data for presenting the hand object in the virtual space 11.

In Step S1880, the processor 210 generates field-of-view image data based on operation of the controller 300 by the user 5. The generated field-of-view data is output to the HMD 120 by the communication control module 540.

In Step S1892, the HMD 120 updates a field-of-view image based on the received view field image data, and displays the updated view field image on the monitor 130.

[Control Structure of Computer]

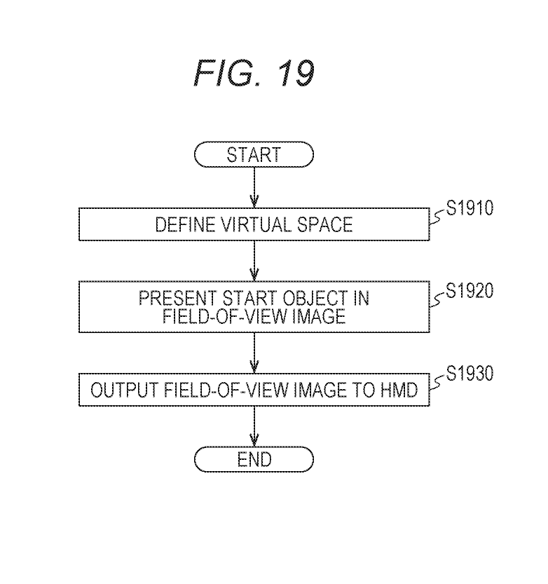

Referring to FIG. 19 to FIG. 23, a description is given of a control structure of the computer 200. FIG. 19 to FIG. 23 are each a flowchart of processing to be executed by the processor 210 of the computer 200 according to at least one aspect of at least one embodiment of this disclosure. FIG. 19 to FIG. 23 are examples of processing to be executed by the computer 200 of Yamada, who receives the online English lesson service.

In FIG. 19, in Step S1910, the processor 210 defines the virtual space 11.

In Step S1920, the processor 210 generates field-of-view image data for presenting a start object in the field-of-view image. The start object is an object for starting the online English lesson service provided by the server 600. In at least one aspect, the user 5 who is a student is able to receive the online English lesson service by operating the controller 300 to move the hand object in the virtual space 11 and operating the start object with the hand object.

In Step S1930, the processor 210 outputs the field-of-view image data generated in Step S1920 to the HMD 120, and ends the processing.

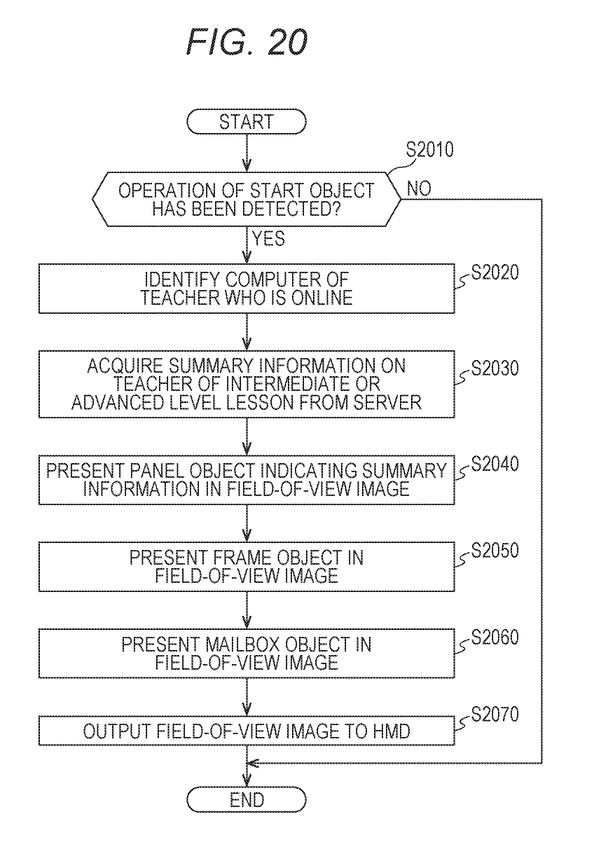

In FIG. 20, in Step S2010, the processor 210 determines whether or not operation of the start object by the student has been detected. When the processor 210 has not detected operation of the start object (NO in Step S2010), the processor 210 ends the processing. Meanwhile, when the processor 210 has detected operation of the start object (YES in Step S2010), in Step S2020, the processor 210 identifies the computer 200 of a teacher who is currently online and teaching the online English lesson service.

In Step S2030, the processor 210 identifies a teacher of an intermediate or advanced level lesson from among the teachers who are currently online, and acquires the teacher's summary information from the teacher information DB of the server 600. In Step S2030, details of the processing differ from user to user based on information on students. For example, as in FIG. 15, in the case of the computer 200 of Sato, in Step S2030, a teacher of an advanced level lesson is identified, and the teacher's summary information is acquired from the teacher information DB of the server 600. For example, in the case of the computer 200 of Suzuki, in Step S2030, a teacher of an elementary level lesson is identified, and the teacher's summary information is acquired from the teacher information DB of the server 600. In this manner, in Step S2030, the computer 200 acquires, from the teacher information DB of the server 600, the summary information on a teacher matching the user 5 who is a student based on the information on the student.

In Step S2040, the processor 210 generates field-of-view image data for presenting, in the field-of-view image, a panel object indicating the summary information acquired in Step S2030. The panel object is an object for selecting a desired teacher. In at least one aspect, the student is able to select a desired teacher by moving the hand object to select a panel object.

In Step S2050, the processor 210 generates field-of-view image data for presenting a frame object in the field-of-view image. The frame object is an object for placing the panel object selected by the student. In at least one aspect, the student moves the hand object to move a panel object to a frame object, to thereby be able to place the panel object on the frame object.

In Step S2060, the processor 210 generates field-of-view image data for presenting a mailbox object in the field-of-view image. The mailbox object is an object for associating the panel object selected by the student with the mailbox object. In at least one aspect, when the student places a panel object on a frame object, the panel object changes to a letter object. The student moves the hand object to move the letter object to a mailbox object, to thereby be able to place the letter object on the mailbox object. When the letter object is placed on the mailbox object, the letter object disappears on the mailbox object as if a letter had entered a mailbox in the real space. In this manner, the panel object selected by the student is associated with the mailbox object.

In Step S2070, the processor 210 outputs the field-of-view image data generated in Step S2040 to Step S2060 to the HMD 120 to end the processing.

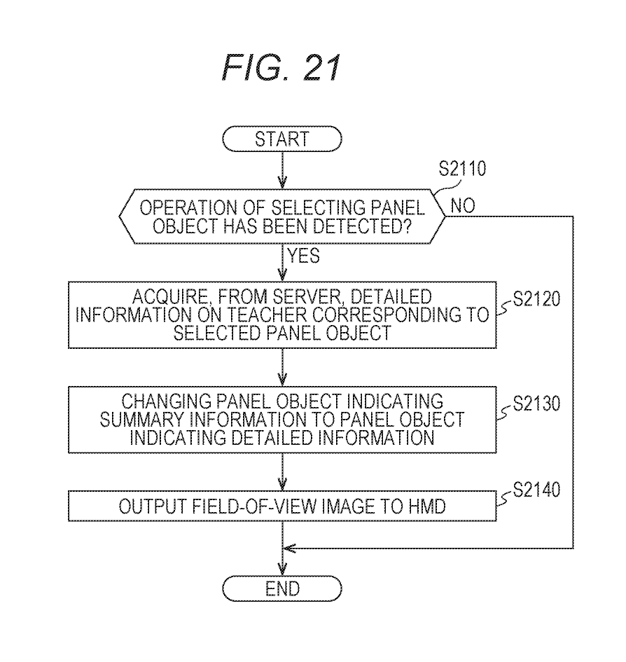

In FIG. 21, in Step S2110, the processor 210 determines whether or not operation of selecting a panel object by the student has been detected. When the processor 210 determines that operation of selecting a panel object has not been detected (NO in Step S2110), the processor 210 ends the processing. Meanwhile, when the processor 210 detects operation of selecting a panel object (YES in Step S2110), in Step S2120, the processor 210 acquires detailed information on a teacher corresponding to the selected panel object from the teacher information DB of the server 600.

In Step S2130, the processor 210 generates field-of-view image data for changing a panel object indicating summary information to a panel object indicating detailed information.

In Step S2140, the processor 210 outputs the field-of-view image data generated in Step S2130 to the HMD 120, and ends the processing.

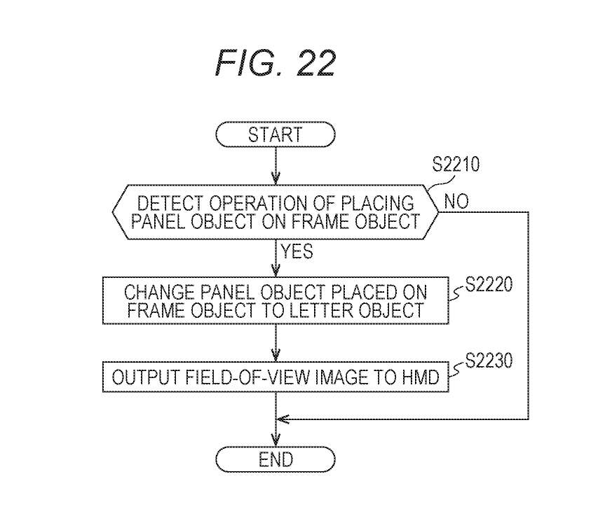

In FIG. 22, in Step S2210, the processor 210 determines whether or not operation of placing a panel object on a frame object has been detected. When the processor 210 has not detected operation of placing a panel object on a frame object (NO in Step S2210), the processor 210 ends the processing. Meanwhile, when the processor 210 detects operation of placing a panel object on a frame object (YES in Step S2210), in Step S2220, the processor 210 generates field-of-view image data for changing the panel object placed on the frame object to a letter object.

In Step S2230, the processor 210 outputs the field-of-view image data generated in Step S2220 to the HMD 120, and ends the processing.

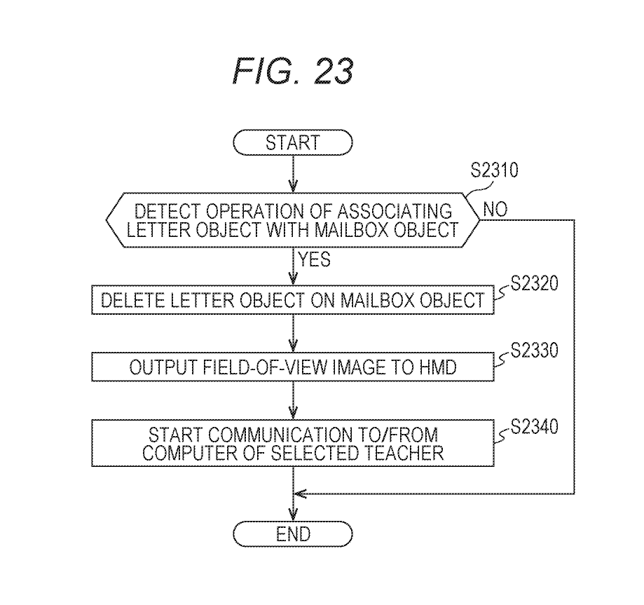

In FIG. 23, in Step S2310, the processor 210 determines whether or not operation of associating a letter object with a mailbox object has been detected. When the processor 210 has not detected operation of associating a letter object with a mailbox object (NO in Step S2310), the processor 210 ends the processing. Meanwhile, when the processor 210 has detected operation of associating a letter object with a mailbox object (YES in Step S2310), in Step S2320, the processor 210 generates field-of-view image data for displaying a field-of-view image so that the letter object disappears on the mailbox object. According to at least one embodiment of this disclosure, the operation of associating a letter object with a mailbox object includes moving the letter object to place the letter object on the mailbox object. The operation of associating a letter object with a mailbox object is not limited to the specific example described above.

In Step S2330, the processor 210 outputs the field-of-view image data generated in Step S2320 to the HMD 120.

In Step S2340, the processor 210 starts communication to/from the computer 200 of the teacher selected by the student, and ends the processing.

As one mode of the processing described above, the mode of executing each step by the computer 200 is exemplified. However, when the HMD 120 includes a processor, the processor may execute any or all of the processing steps described with respect to FIGS. 19-23.

[Change in Object Presented in Virtual Space]

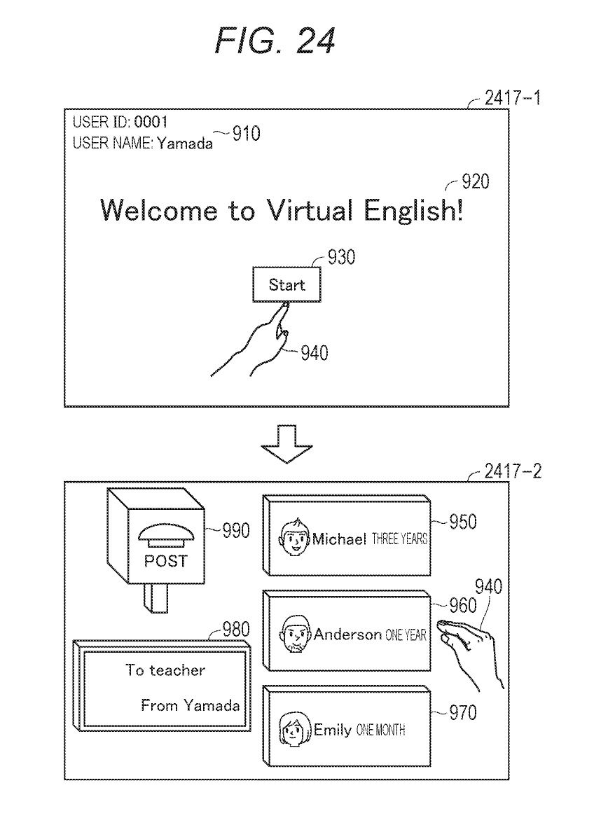

Now, referring to FIG. 24 to FIG. 27, a description is given of a change in object presented in the virtual space 11. FIG. 24 to FIG. 27 are diagrams of an example of a change in object presented in the virtual space 11 according to at least one embodiment of this disclosure.

FIG. 24 is an diagram of field-of-view images 2417-1 and 2417-2 displayed on the monitor 13 of the HMD 120. The field-of-view images 2417-1 and 2417-2 are images provided to the user 5 by the HMD 120. The user 5 in this example is Yamada, who is a student.

In FIG. 24, in at least one aspect, a user object 910 indicating a user ID and a user name, which are a part of student information on Yamada, is presented in the field-of-view image 2417-1. A title object 920 indicating “Welcome to Virtual English!”, which is the title of the online English lesson service, is presented in the field-of-view image 2417-1. Further, a start object 930 and a hand object 940 are presented in the field-of-view image 2417-1. The presentation of the start object 930 is based on the processing of Step S1920 and Step S1930 illustrated in FIG. 19.

When the student moves the hand object 940 to operate the start object 930, the field-of-view image 2417-1 is switched to the field-of-view image 2417-2. A plurality of panel objects 950 to 970 are presented in the field-of-view image 2417-2. The presentation of the panel objects 950 to 970 is based on the processing of Step S2040 and Step S2070 in FIG. 20.

The panel object 950 indicates “Michael”, which is the user name, an avatar object corresponding to “a”, and “3 years”, which is the membership period, as the summary information on Michael. The panel object 960 indicates “Anderson”, which is the user name, an avatar object corresponding to “c”, and “1 year”, which is the membership period, as the summary information on Anderson. The panel object 970 indicates “Emily”, which is the user name, an avatar object corresponding to “e”, and “1 month”, which is the membership period, as the summary information on Emily. Michael, Anderson, and Emily are online, and match the course (intermediate level course or advanced level course) of Yamada, who is a student. For example, in FIG. 16, Olivia teaches an advanced level lesson. However, Olivia is offline, and thus is not presented on the panel object. Bob is online. However, Bob teaches an elementary level lesson, and thus is not presented on the panel object. Depending on a relationship between online status of teachers and the course of a student, only the panel object corresponding to one teacher may be presented, or no panel object corresponding to a teacher may be presented if no teachers are online that match the criteria of the student user.

A frame object 980 is presented in the field-of-view image 2417-2. The presentation of the frame object 980 is based on the processing of Step S2050 and Step S2070 in FIG. 20. Further, a mailbox object 990 is presented in the field-of-view image 2417-2. The presentation of the mailbox object 990 is based on the processing of Step S2060 and Step S2070 in FIG. 20.

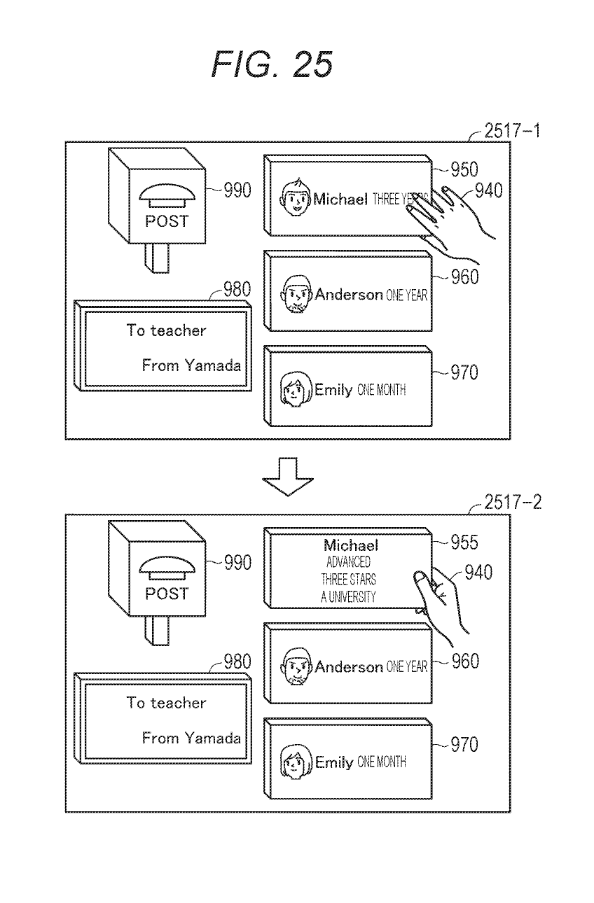

FIG. 25 is a diagram of field-of-view images 2517-1 and 2517-2 displayed on the monitor 130 of the HMD 120. The field-of-view images 2517-1 and 2517-2 are images provided to the user 5 by the HMD 120 after the presentation of the field-of-view image 2417-2.

In FIG. 25, the student is able to select a desired panel object from among the plurality of panel objects 950 to 970 by moving the hand object 940. In this manner, the student is able to select a desired teacher from among the plurality of presented teachers. For example, the hand object 940 touches the panel object 950 corresponding to Michael in the field-of-view image 2517-1. In this manner, in at least one aspect, the student is able to select the panel object 950 by touching the panel object 950 with the hand object 940. When only the panel object corresponding to one teacher is presented, the student is able to select only the panel object corresponding to the one teacher. When no panel object corresponding a teacher is presented, the student cannot select a panel object.

The student is able to check detailed information on the selected teacher by moving the hand object 940. For example, in the field-of-view image 2517-2, the panel object is changed from the panel object 950 indicating the summary information on Michael to a panel object 955 indicating the detailed information on Michael by turning over the panel object 950 with the hand object 940. In this manner, in at least one aspect, the student turns over the panel object 950 with the hand object 940, to thereby be able to check the detailed information on a teacher. The change in the panel object 950 to the panel object 955 is based on the processing of Step S2130 and Step S2140 in FIG. 21.

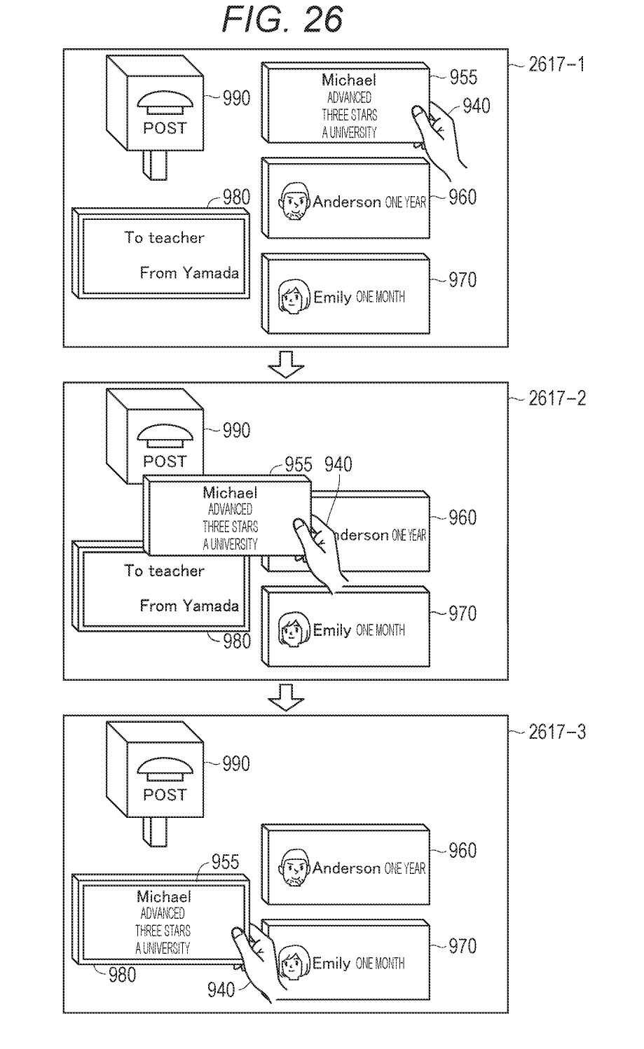

FIG. 26 is a diagram of field-of-view images 2617-1 to 2617-3 displayed on the monitor 130 of the HMD 120. The field-of-view images 2617-1 to 2617-3 are images provided to the user 5 by the HMD 120 after the presentation of the field-of-view image 2517-2.

In FIG. 26, the panel object 955 is grasped with the hand object 940 in the field-of-view image 2617-1. The panel object 955 corresponding to Michael is moved to the frame object 980 with the hand object 940 in the field-of-view image 2617-2. After that, the panel object 955 is placed on the frame object 980 in the field-of-view image 2617-3. In this manner, in at least one aspect, the student moves the panel object 955 with the hand object 940, to thereby be able to place the panel object 955 on the frame object 980.

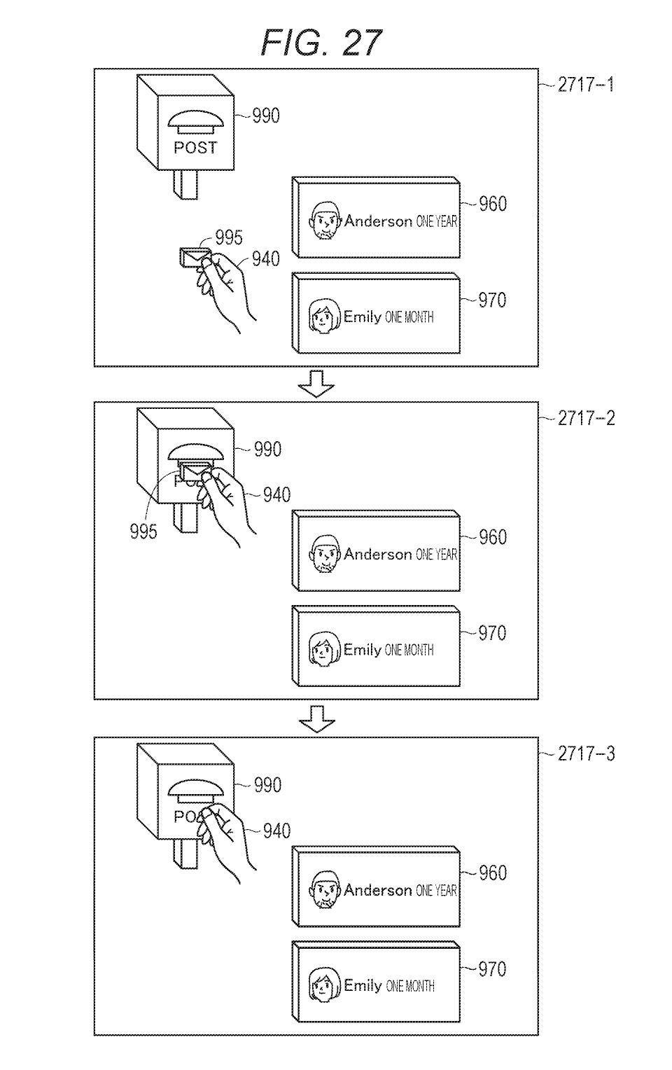

FIG. 27 is a diagram of field-of-view images 2717-1 to 2717-3 displayed on the monitor 130 of the HMD 120. The field-of-view images 2717-1 to 2717-3 are images provided to the user 5 by the HMD 120 after the presentation of the field-of-view image 2617-3.

In FIG. 27, the student is able to associate the selected panel object 950 (955) with the mailbox object 990 by moving the hand object 940. For example, the panel object 955 placed on the frame object 980 is changed to a letter object 995 in the field-of-view image 2717-1. The change in the panel object 955 to the letter object 995 is based on the processing of Step S2220 and Step S2230 in FIG. 22.

The letter object 995 is placed on the mailbox object 990 by the hand object 940 in the field-of-view image 2717-2. When the letter object 995 is placed on the mailbox object, the letter object 995 disappears on the mailbox object 990 as if a letter had entered a mailbox in the real space. The association of the panel object 950 (955) with the mailbox object 990 is based on the processing of Step S2320 and Step S2330 in FIG. 23.

[Communication Established State]

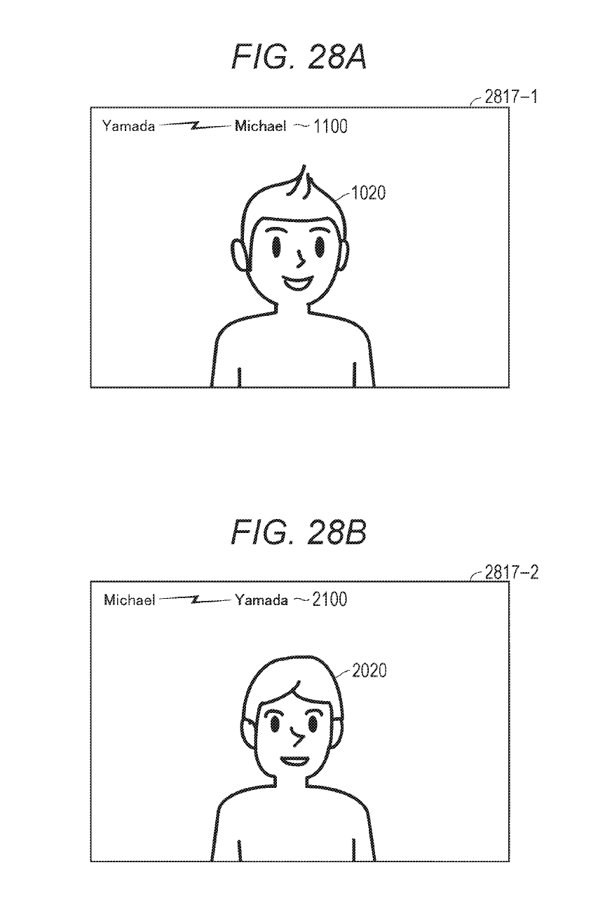

Now, referring to FIG. 28A and FIG. 28B, a description is given of a state in which communication between the computer 200 of a student and the computer 200 of a teacher is established. FIG. 28A and FIG. 28B are diagrams of examples of the state in which communication is established in the virtual space 11 according to at least one embodiment of this disclosure.

FIG. 28A is a diagram of a field-of-view image 2817-1 displayed on the monitor 130 of the HMD 120 worn by Yamada, who is a student, in at least one aspect. FIG. 28B is a diagram of a field-of-view image 2817-2 displayed on the monitor 130 of the HMD 120 worn by Michael, who is a teacher, in at least one aspect.

In FIG. 28A, the field-of-view image 2817-1 presents an object 1100 representing a state in which communication between the computer 200 of Yamada and the computer 200 of Michael is established. The field-of-view image 2817-1 presents an avatar object 1020 corresponding to Michael.

Meanwhile, in FIG. 28B, the field-of-view image 2817-2 presents an object 2100 representing a state in which communication between the computer 200 of Michael and the computer 200 of Yamada is established. The field-of-view image 2817-2 presents an avatar object 2020 corresponding to Yamada.

In this manner, when communication is established between the computer 200 of the student and the computer 200 of the teacher, an avatar object of a communication partner is presented on the monitor 130 of each of the HMDs 120. After the communication is established, the student and the teacher may have a conversation with each other using the speakers 180 and the microphones 170 of the respective HMDs 120.

As described above, as in the case of the real space in which the user 5 sends a letter to a communication partner, communication is established between the computer 200 of the user 5 and the computer 200 of another user by an avatar object corresponding to the user 5 sending a letter to a communication partner also in the virtual space.

[Other Configurations]

In at least one aspect, the configuration of this disclosure is not limited to selection of a teacher in the online English lesson service. Besides, the configuration of this disclosure is applied to any service as long as one or more other users are selected from among one or more other users presented in the virtual space 11. For example, the configuration of this disclosure is applied to services such as selection of a conversation partner in a chat, selection of an opponent or a team member in a competitive game, or selection of a team member in a role-playing game.

In at least one aspect, the user 5 selects a plurality of other users from among a plurality of other users presented in the virtual space 11. In this case, the computer 200 of the user 5 may establish communication to/from the respective computers 200 of the selected plurality of other users. The computer 200 may present avatar objects respectively corresponding to the selected plurality of other users in the virtual space 11.

In at least one aspect, the computer 200 presents, in the virtual space 11, not only a panel object corresponding to another user who is online, but also a panel object corresponding to another user who is offline. For example, in a competitive game, when the user 5 selects a plurality of other users who are offline, the computer 200 may present avatar objects corresponding to the selected plurality of other users in the virtual space 11. Alternatively, in a competitive game, when the user 5 selects another user who is offline, the computer 200 may present an avatar object corresponding to the selected user who is offline in the virtual space 11, and also move the avatar object without operation by the selected user. Alternatively, in a competitive game, when the user 5 selects another user who is offline, the computer 200 may present the avatar object corresponding to the selected user in the virtual space 11 when the selected user switches to the online state later.

In at least one aspect, each user preliminarily selects a favorite user from among a plurality of users, and data on the favorite user is stored in the memory 220 of the computer 200 or the memory 620 of the server. In this case, the computer 200 may present, in the virtual space 11 as selectable options, one or more other users including another user selected by the user 5 as a favorite. When the user 5 has not selected any user as a favorite, the computer 200 may present, in the virtual space 11 as selectable options, one or more other users including other users who have selected the user 5 as a favorite. When none of the other users has selected the user 5 as a favorite, the computer 200 may present, in the virtual space 11 as selectable options, one or more other users including another user selected by the computer 200 or the server 600. In this case, the computer 200 or the server 600 may present, based on information on the user 5, the one or more other users including another user that matches the information in the virtual space 11.

In at least one aspect, the computer 200 presents, in the virtual space 11 as selectable options, one or more other users having information similar to that on the user 5 based on the information on the user 5. For example, in a chat, the computer 200 may present, in the virtual space 11 as selectable options, one or more other users having a hobby similar to that of the user 5. For example, in a competitive game, the computer 200 may present, in the virtual space 11 as selectable options, one or more other users having a combat experience that is the same as or similar to that of the user 5.

In at least one aspect, the user 5 selects an object corresponding to another user by moving a partial object corresponding to a part of the body of the user 5 without moving the hand object. In order to establish communication to/from another user, the user 5 may associate an object corresponding to another user with another object by moving a partial object corresponding to a part of the body of the user 5 instead of moving the hand object.

[Summary of at Least One Embodiment of this Disclosure]

The disclosed technical features of at least one embodiment include the following configurations, for example.

(Configuration 1)

According to at least one embodiment of this disclosure, there is provided a method to be executed on a computer 200 to communicate via a virtual space 11. The method includes defining (Step S1810 and Step S1910) the virtual space 11. The method further includes presenting (Step S2040 and Step S2070), in the virtual space 11, one or more panel objects 950 to 970 corresponding to one or more other users capable of communicating to/from a user 5 of the computer 200. The method further includes presenting (Step S2060 and Step S2070) a mailbox object 990 different from the one or more panel objects 950 to 970 in the virtual space 11. The method further includes selecting (Step S2110) one or more panel objects 950 from among the one or more panel objects 950 to 970. The method further includes associating (Step S2310, Step S2320, and Step S2330) the selected one or more panel objects 950 with the mailbox object 990. The method further includes communicating (Step S2340) to/from a computer 200 of another user corresponding to the selected one or more panel objects 950 based on the selected one or more panel objects 950 being associated with the mailbox object 990.

(Configuration 2)

According to at least one embodiment of this disclosure, the method further includes changing (Step S2130 and Step S2140) a panel object from a panel object 950 indicating summary information on another user to a panel object 955 indicating detailed information on the another user.

(Configuration 3)

According to at least one embodiment of this disclosure, the method further includes presenting (Step S1870), in the virtual space 11, a hand object 940 corresponding to a hand of the user 5 of the computer 200 communicating via the virtual space 11. The method further includes detecting motion of the hand (Step S1865). The method further includes moving (Step S1880) the hand object 940 based on the motion of the hand. The changing of the panel object includes changing (Step S2110), with the hand object 940, the panel object from the panel object 950 indicating the summary information to the panel object 955 indicating the detailed information.

(Configuration 4)

According to at least one embodiment of this disclosure, the method further includes changing (Step S2220 and Step S2230) a panel object from the panel object 955 indicating the detailed information to a letter object 995 to be associated with the mailbox object 990 to communicate to/from the computer 200 of the another user.

(Configuration 5)

According to at least one embodiment of this disclosure, the method further includes presenting (Step S1870), in the virtual space 11, a hand object 940 corresponding to a hand of the user 5 of the computer 200 communicating via the virtual space 11. The method further includes detecting (Step S1865) motion of the hand. The method further includes moving (Step S1880) the hand object 940 based on the motion of the hand. The changing of the panel object includes changing (Step S2310), with the hand object 940, the panel object from the panel object 955 indicating the detailed information to the letter object 995 to be associated with the mailbox object 990.

(Configuration 6)

According to at least one embodiment of this disclosure, the detailed information includes more detailed information on the another user than the summary information.

(Configuration 7)

According to at least one embodiment of this disclosure, the method further includes presenting (Step S1870), in the virtual space 11, a hand object 940 corresponding to a hand of the user 5 of the computer 200 communicating via the virtual space 11. The method further includes detecting (Step S1865) motion of the hand. The method further includes moving (Step S1880) the hand object 940 based on the motion of the hand. The selecting of the one or more panel objects 950 includes selecting (Step S2110) one or more panel objects 950 from among the one or more panel objects 950 to 970 with the hand object 940.

(Configuration 8)

According to at least one embodiment of this disclosure, the method further includes presenting (Step S1870), in the virtual space 11, a hand object 940 corresponding to a hand of the user 5 of the computer 200 communicating via the virtual space 11. The method further includes detecting (Step S1865) motion of the hand. The method further includes moving (Step S1880) the hand object 940 based on the motion of the hand. The associating of the selected one or more panel objects 950 with the mailbox object 990 includes associating (Step S2310) the selected one or more panel objects 950 with the mailbox object 990 with the hand object 940.

(Configuration 9)

According to at least one embodiment of this disclosure, the presenting of the panel objects 950 to 970 in the virtual space 11 includes presenting (Step S2030) a plurality of panel objects 950 to 970 based on information on the user 5 of the computer 200 communicating via the virtual space 11.

(Configuration 10)

According to at least one embodiment of this disclosure, there is provided a system for executing any one of the methods described above.

(Configuration 11)

According to at least one embodiment of this disclosure, there is provided a computer 200 including a memory 220 having stored thereon a program for executing any of the methods described above; and a processor 210 for executing the program.

As described above, according to at least one embodiment of this disclosure, the user 5 selects one or more panel objects from among one or more panel objects corresponding to one or more other users presented in the virtual space 11. When the user 5 associates the selected panel object with the mailbox object 990, the computer 200 of the user 5 communicates to/from another user corresponding to the selected panel object. In this manner, the user 5 is able to communicate to/from another user by performing motion in the virtual space that is similar to that in the real space. Therefore, the user 5 is able to communicate to/from another user without impairing the sense of immersion into the virtual space. In this case, communicating to/from the computer 200 of another user corresponding to the selected panel object by the computer 200 of the user 5 when associating the selected panel object with the mailbox object 990 may include transmitting, to the computer 200 of the another user, a message for inviting an avatar object corresponding to the another user to the virtual space 11 defined by the computer 200 of the user 5.

It is to be understood that the embodiments disclosed herein are merely examples in all aspects and in no way intended to limit this disclosure. The scope of this disclosure is defined by the appended claims and not by the above description, and it is intended that this disclosure encompasses all modifications made within the scope and spirit equivalent to those of the appended claims.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, it is possible to exert action on the target object based on motion of the hand of the user.

1-8. (canceled)

9. A method, comprising:
defining a virtual space associated with a first user, wherein the virtual space comprises a first object associated with a second user and a second object different from the first object;
selecting the first object in response to input by the first user;
associating the selected first object with the second object within the virtual space in response to input by the first user; and
establishing communication between the first user and second user associated with the first object in response to the first object and the second object being associated with each other.

10. The method according to claim 9, further comprising:
changing a state of the first object from a first state to a second state in response to the first object being selected,
wherein, in the first state, the first object indicates first information related to the second user, and
wherein, in the second state, the first object indicates second information related to the second user, and the first information is different from the second information.

11. The method according to claim 10, further comprises:
detecting motion of a part of a body of the first user other than a head of the first user;
moving a third object in the virtual space in response to the detected motion;
selecting the first object in response to motion of the third object; and
changing the state of the first object from the first state to the second state in response to the first object being selected by the third object.

12. The method according to claim 10, further comprising:
changing the state of the first object from the second state to a third state in response to the first object being selected,
wherein, in the third state, the first object is released from the second state, and is in a state of indicating to the first user that communication between the first user and the second user is to be started by associating the first object with the second object.

13. The method according to claim 12, further comprises:
detecting motion of a part of a body of the first user other than a head of the first user;
moving a third object in the virtual space in response to the detected motion;
selecting the first object in response to motion of the third object; and
changing the state of the first object from the second state to the third state in response to the first object being selected by the third object.

14. The method according to claim 10, wherein the second information comprises more detailed information related to the second user than the first information.

15. The method according to claim 9, further comprises:
detecting motion of a part of a body of the first user other than a head of the first user;
moving a third object in the virtual space in response to the detected motion; and
selecting the first object in response to motion of the third object.

16. The method according to claim 9, further comprising:
moving a third object in the virtual space in response to a detected movement of a part of a body of the first user other than a head of the first user;
selecting the first object using the third object;
moving the first object in synchronization with motion of the third object in response to selection of the first object by the third object; and
associating the first object with the second object in response to the first object being moved to a position overlapping of the second object in the virtual space.

17. A system, comprising:
a non-transitory computer readable medium configured to store a program thereon; and
a processor connected to the non-transitory computer readable medium, wherein the processor is configured to execute the program for:
defining a virtual space associated with a first user, wherein the virtual space comprises a first object associated with a second user and a second object different from the first object;
selecting the first object in response to input by the first user;
associating the selected first object with the second object within the virtual space in response to input by the first user; and
establishing communication between the first user and second user associated with the first object in response to the first object and the second object being associated with each other.

18. The system according to claim 17, wherein the processor is further configured to execute the program for:
changing a state of the first object from a first state to a second state in response to the first object being selected,
wherein, in the first state, the first object indicates first information related to the second user, and
wherein, in the second state, the first object indicates second information related to the second user, and the first information is different from the second information.

19. The system according to claim 18, wherein the processor is further configured to execute the program for:
detecting motion of a part of a body of the first user other than a head of the first user;
moving a third object in the virtual space in response to the detected motion;
selecting the first object in response to motion of the third object; and
changing the state of the first object from the first state to the second state in response to the first object being selected by the third object.

20. The system according to claim 18, wherein the processor is further configured to execute the program for:
changing the state of the first object from the second state to a third state in response to the first object being selected,
wherein, in the third state, the first object is released from the second state, and is in a state of indicating to the first user that communication between the first user and the second user is to be started by associating the first object with the second object.

21. The system according to claim 20, wherein the processor is further configured to execute the program for:
detecting motion of a part of a body of the first user other than a head of the first user;
moving a third object in the virtual space in response to the detected motion;
selecting the first object in response to motion of the third object; and
changing the state of the first object from the second state to the third state in response to the first object being selected by the third object.

22. The system according to claim 18, wherein the second information comprises more detailed information related to the second user than the first information.

23. The system according to claim 17, wherein the processor is further configured to execute the program for:
detecting motion of a part of a body of the first user other than a head of the first user;
moving a third object in the virtual space in response to the detected motion; and
selecting the first object in response to motion of the third object.

24. The system according to claim 17, wherein the processor is further configured to execute the program for:
moving a third object in the virtual space in response to a detected movement of a part of a body of the first user other than a head of the first user;
selecting the first object using the third object;
moving the first object in synchronization with motion of the third object in response to selection of the first object by the third object; and
associating the first object with the second object in response to the first object being moved to a position overlapping of the second object in the virtual space.

25. A method, comprising:
defining a virtual space associated with a first user, wherein the virtual space comprises a user object associated with the first user, a first object associated with a second user and a second object associated with a third user;
moving the user object within the virtual space in response to a detected movement of a part of a body of the first user other than a head of the first user;
selecting the first object or the second object in response to a first input by the first user;
associating the selected first object or second object with a third object within the virtual space in response to a second input by the first user; and
establishing communication between the first user and the second user in response to the first object being associated with the third object; and
establishing communication between the first user and the third user in response to the second object being associated with the third object.

26. The method according to claim 25, further comprising displaying detailed information related to the second user in response to selection of the first object by the user object.

27. The method according to claim 25, wherein the associating of the second object with the third object comprises moving the second object to a position overlapping the third object in the virtual space.

28. The method according claim 25, wherein the establishing of communication between the first user and the second user comprises displaying an avatar object associated with the second user to the first user.
